(19) United States
(12) Patent Application Publication
(10) Pub. No.: US 2026/0203071 A1
(43) Pub. Date: Jul. 16, 2026

(54) BOOTSTRAP STORAGE SHARING FOR HCI SYSTEM MANAGEMENT IN MULTI-CLOUD

(71) Applicant: Dell Products L.P., Round Rock, TX (US)

(72) Inventors: Haijun ZHONG, Shanghai (CN); Sen LIN, Shanghai (CN); XiaoJun WU, Shanghai (CN)

(73) Assignee: Dell Products L.P., Round Rock, TX (US)

(21) Appl. No.: 19/033,304

(22) Filed: Jan. 21, 2025

(30) Foreign Application Priority Data
Jan. 14, 2025 (CN) 202510055878.3

(51) Int. Cl. G06F 9/4401; G06F 8/65

(52) U.S. Cl. CPC G06F 9/4406; G06F 8/65; G06F 9/4411

(57) ABSTRACT

An information handling system may include a main physical storage resource and a bootstrap physical storage resource. The information handling system may be configured to: boot from a bootstrap operating system (OS) stored on the bootstrap physical storage resource; install, by the bootstrap OS, a main OS onto the main physical storage resource; expose the bootstrap physical storage resource as a drive that is accessible from the main OS; and in response to a change in hardware, software, or firmware of the information handling system, update the bootstrap OS from the main OS.

### TECHNICAL FIELD

The present disclosure relates in general to information handling systems, and more particularly to the management of bootstrap storage resources.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In both the HCI context and the non-HCI context, it may sometimes be necessary to repurpose a system. For example, the administrator of an HCI cluster may decide to remove a node from that cluster, install different software on it, and put it to use in a different cluster.

A node may include a bootstrap operating system (OS) on a bootstrap storage resource. A bootstrap storage resource is a storage resource that is separate from the main hard drives or solid-state drives included in the system. Typically, the bootstrap storage resource is relatively small, and the bootstrap OS stored thereon has limited functionality (unlike a full OS). The bootstrap OS may be used when the system is first being set up or is being repurposed. For example, the user may instruct the system to boot from the bootstrap OS, which may then run and install the regular OS selected by the user onto the main storage device.

The bootstrap OS may also be used to solve problems with the system. For example, if the OS on the main storage resource becomes corrupted, it may be repaired or reinstalled from the bootstrap OS. Or if a standard tool needs to be reinstalled, this may also be done from the bootstrap OS.

A problem may arise, however, if the hardware, software, or firmware of the system has been updated in a way that the bootstrap OS is not prepared for. For example, the bootstrap OS may not have drivers for the new hardware or may not be able to interact with a new firmware version installed on some device. Embodiments of this disclosure provide techniques for updating the bootstrap OS to avoid such concerns.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with bootstrap storage resources may be reduced or eliminated.

In accordance with embodiments of the present disclosure, an information handling system may include a main physical storage resource and a bootstrap physical storage resource. The information handling system may be configured to: boot from a bootstrap operating system (OS) stored on the bootstrap physical storage resource; install, by the bootstrap OS, a main OS onto the main physical storage resource; expose the bootstrap physical storage resource as a drive that is accessible from the main OS; and in response to a change in hardware, software, or firmware of the information handling system, update the bootstrap OS from the main OS.

In accordance with these and other embodiments of the present disclosure, a method may include an information handling system that includes a main physical storage resource and a bootstrap physical storage resource booting from a bootstrap operating system (OS) stored on the bootstrap physical storage resource; the information handling system installing, by the bootstrap OS, a main OS onto the main physical storage resource; the information handling system exposing the bootstrap physical storage resource as a drive that is accessible from the main OS; and in response to a change in hardware, software, or firmware of the information handling system, the information handling system updating the bootstrap OS from the main OS.

In accordance with these and other embodiments of the present disclosure, an article of manufacture may include a non-transitory, computer-readable medium having computer-executable instructions thereon that are executable by a processor of an information handling system that includes a main physical storage resource and a bootstrap physical storage resource for: booting from a bootstrap operating system (OS) stored on the bootstrap physical storage resource; installing, by the bootstrap OS, a main OS onto the main physical storage resource; exposing the bootstrap physical storage resource as a drive that is accessible from the main OS; and in response to a change in hardware, software, or firmware of the information handling system, updating the bootstrap OS from the main OS.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of another example information handling system, in accordance with embodiments of the present disclosure.

### DETAILED DESCRIPTION

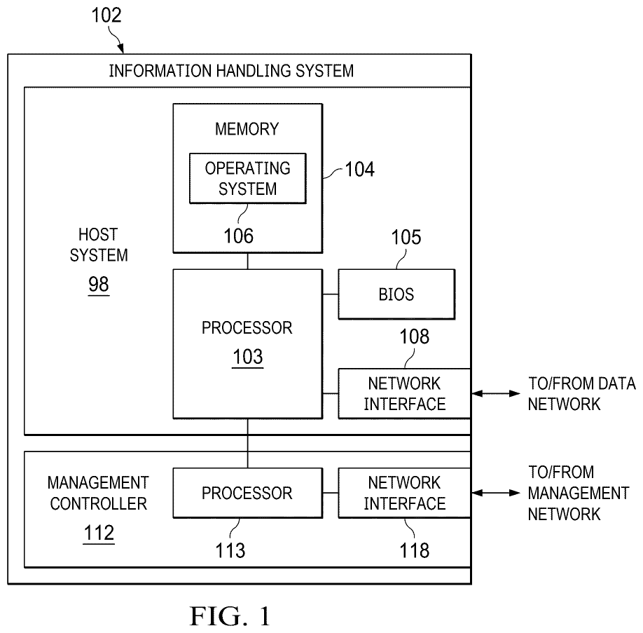

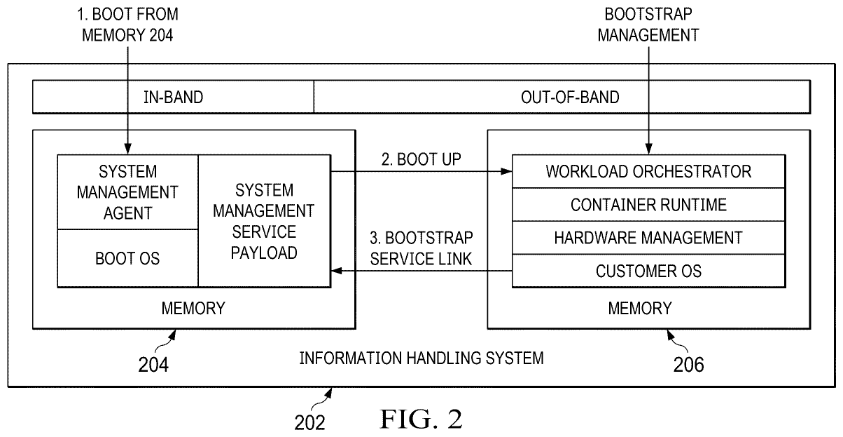

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, information handling system 102 may be a node of an HCI system. Memory 104 may include one or more main storage resources to host operating system 106 and other software, and it may also include a separate bootstrap storage resource (not shown separately in this view).

Over its lifetime, information handing system 102 may have various hardware, firmware, and software components replaced. For example, accelerator cards may be replaced with upgraded versions, failed components may be replaced with components from different brands, etc. These changes may cause issues with the bootstrap OS, if it is not updated to be able to handle the new components.

FIG. 2 shows an example of selected components of another information handling system 202. Memory 206 is the main physical storage resource of the system, and it includes components such as the main customer OS, a hardware management component, a workload orchestrator such as Kubernetes, and a container runtime.

Information handling system 202 also includes memory 204, which is a smaller bootstrap storage resource. Memory 204 includes a bootstrap OS (used for repair and replacement of the customer OS on memory 206), a system management agent, and a system management service payload.

The hardware management component may be a tool provided by a vendor of information handling system that is configured to ascertain the hardware state of the system. This information is used to choose the correct hardware installation configuration that will be configured during the installation of the customer OS.

When information handling system 202 is built at the factory, memory 204 may be formatted into a partition including the bootstrap OS, as well as any other tools needed to allow the customer to set the system up. When the customer receives the system, the bootstrap OS may start up and provide options for what type of customer OS to install. The bootstrap OS may then install the desired customer OS to memory 206, as well as populating it with the hardware management component. During this process, the system management agent in memory 204 may be loaded and running to provide hardware information needed during the installation of the customer OS.

As discussed in more detail below, when the customer OS is later updated or other changes are made to information handling system 202, embodiments may also perform corresponding updates to the bootstrap OS. This may ensure that the system management agent is always up to date and does not encounter errors due to being unable to interface with new components of information handling system. Thus the next time the system needs to be repurposed, the bootstrap OS may perform correctly.

In particular, once the customer OS has been installed, memory 204 or a partition thereof may be exposed as a shared drive that is accessible from within the customer OS. Once the customer OS is operational, the hardware management component of the customer OS may keep track of any changes that are made to the system's hardware, firmware, and software. It may then propagate corresponding changes to the bootstrap OS. For example, it may download a new version of the bootstrap OS from the manufacturer and install that new version onto memory 204. In other embodiments, the hardware management component may inject new drivers into the existing bootstrap OS as a system management payload.

The hardware management component may also be accessed out-of-band by the HCI management system that governs the overall cluster, providing centralized control over the updates to the bootstrap OS configuration on each node.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a main physical storage resource; and
a bootstrap physical storage resource;
wherein the information handling system is configured to:
boot from a bootstrap operating system (OS) stored on the bootstrap physical storage resource;
install, by the bootstrap OS, a main OS onto the main physical storage resource;
expose the bootstrap physical storage resource as a drive that is accessible from the main OS; and
in response to a change in hardware, software, or firmware of the information handling system, update the bootstrap OS from the main OS.

2. The information handling system of claim 1, wherein the information handling system is a node of a hyper-converged infrastructure (HCI) system.

3. The information handling system of claim 1, wherein the bootstrap physical storage resource has a smaller storage capacity than the main physical storage resource.

4. The information handling system of claim 1, wherein exposing the bootstrap physical storage resource comprises exposing a partition of the bootstrap physical storage resource.

5. The information handling system of claim 1, wherein updating the bootstrap OS comprises installing a new version of the bootstrap OS.

6. The information handling system of claim 1, wherein updating the bootstrap OS comprises adding a new driver to the bootstrap OS.

7. A method comprising:
an information handling system that includes a main physical storage resource and a bootstrap physical storage resource booting from a bootstrap operating system (OS) stored on the bootstrap physical storage resource;
the information handling system installing, by the bootstrap OS, a main OS onto the main physical storage resource;
the information handling system exposing the bootstrap physical storage resource as a drive that is accessible from the main OS; and
in response to a change in hardware, software, or firmware of the information handling system, the information handling system updating the bootstrap OS from the main OS.

8. The method of claim 7, wherein the information handling system is a node of a hyper-converged infrastructure (HCI) system.

9. The method of claim 7, wherein the bootstrap physical storage resource has a smaller storage capacity than the main physical storage resource.

10. The method of claim 7, wherein exposing the bootstrap physical storage resource comprises exposing a partition of the bootstrap physical storage resource.

11. The method of claim 7, wherein updating the bootstrap OS comprises installing a new version of the bootstrap OS.

12. The method of claim 7, wherein updating the bootstrap OS comprises adding a new driver to the bootstrap OS.

13. An article of manufacture comprising a non-transitory, computer-readable medium having computer-executable instructions thereon that are executable by a processor of an information handling system that includes a main physical storage resource and a bootstrap physical storage resource for:
booting from a bootstrap operating system (OS) stored on the bootstrap physical storage resource;
installing, by the bootstrap OS, a main OS onto the main physical storage resource;
exposing the bootstrap physical storage resource as a drive that is accessible from the main OS; and
in response to a change in hardware, software, or firmware of the information handling system, updating the bootstrap OS from the main OS.

14. The article of manufacture of claim 13, wherein the information handling system is a node of a hyper-converged infrastructure (HCI) system.

15. The article of manufacture of claim 13, wherein the bootstrap physical storage resource has a smaller storage capacity than the main physical storage resource.

16. The article of manufacture of claim 13, wherein exposing the bootstrap physical storage resource comprises exposing a partition of the bootstrap physical storage resource.

17. The article of manufacture of claim 13, wherein updating the bootstrap OS comprises installing a new version of the bootstrap OS.

18. The article of manufacture of claim 13, wherein updating the bootstrap OS comprises adding a new driver to the bootstrap OS.
